(19) United States
(12) Patent Application Publication
(10) Pub. No.: US 2007/0182953 A1
(43) Pub. Date: Aug. 9, 2007

(54) Inspection apparatus for conveyor system

(76) Inventor: Donald T. Tassic, Northville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/348,492

(22) Filed: Feb. 6, 2006

(51) Int. Cl. G01N 21/00

(52) U.S. Cl. 356/237.1

(57) ABSTRACT

A video monitor for a conveyor system consists of a camera assembly, a recorder assembly and a power supply. The camera assembly includes a camera tube which contains the camera. The camera tube is movable so as to avoid impeding the movement of the conveyor. The camera tube is attached to a swivel, allowing the camera tube to pivot if the camera tube comes in contact with an obstruction.

### BACKGROUND OF THE INVENTION

In conventional assembly lines, a continuous feed of partially completed assemblies, such as an automobile, is passed through a large number of assembly stations. The assemblies are transported by way of a conveyor. In many applications, an overhead chain conveyor is used to transport the assemblies. Chain conveyors can include overhead monorail, overhead power and free or inverted power and free. Power and Free type chain conveyors include a power rail “I-beam” which consists of trolleys and chain and a free rail channel that guides a carrier trolley along allowing jobs to accumulate prior to a specific process.

One type of overhead chain conveyor is an I-Beam trolley conveyor, also referred to as an overhead monorail conveyor. In such a conveyor, a chain is supported by a plurality of trolleys rolling on an I-beam flange. A drive is used to move the chain, which results in movement of the trolleys. A variety of attachments such as drop fingers can be mounted to the chain. Assemblies are placed on the drop fingers. The I-beam is generally supported by overhead hangers.

The conveyor system is often exposed to harsh chemicals. For example, an automobile component may be immersed in an acid bath. The conveyor system also must be present in the same area as the acid bath. Over time, the environment in proximity to the acid bath can seriously degrade the condition of the conveyor I-Beam and trolleys. Periodic monitoring of the conveyor is therefore required in order to ensure timely repair and maintenance of the conveyor system.

Monitoring of the conveyor is problematic. Because the conveyor system may be suspended well above the assembly stations, access to the conveyor system is difficult. For example, the hangers are critical to the integrity of the conveyor system, but due to their location are very difficult to inspect. Similarly, areas of the assembly line may be located in enclosed areas, thus requiring an inspector to gain access to an enclosed area for inspection. Further, the environment around a section of the conveyor can also be dangerous, as is the case with a portion of a conveyor located near an acid bath. Finally, to insure safety of the inspector, the conveyor system often cannot be operated during inspection. The inspection is therefore performed under circumstances much different from the actual operation of the conveyor.

In order to effectively inspect the conveyor, the conveyor must be disabled during the inspection. The down time for the conveyor during an inspection, resulting in considerable loss of production.

An improved method and apparatus for inspection of a conveyor system is highly desirable which is both safer and more effective.

### SUMMARY OF THE INVENTION

An improved apparatus for inspection of a conveyor system includes a camera assembly, a recorder and a battery. The camera assembly is adapted to be attached to the conveyor transport means, which, in the case of an I-beam conveyor system, is a chain. While different means can be used to attach the camera assembly to the conveyor transport means, one such means is bolts located at the base of the camera assembly. Alternatively, the camera assembly could be integral with a link.

The camera assembly includes a camera tube. The camera tube has an LED light located on the exterior of the tube for lighting. A port on the camera tube allows light to enter the camera tube. The port may be open or it may include a lens. A mirror, placed at angle of about 45 degrees, directs light from the outside onto a camera, such as a CCD sensor array. The CCD sensor array is connected to the recorder assembly.

The camera tube is moveable within a swivel. The camera tube can be adjusted up and down within the swivel so as to control the height of the port. Additionally, the camera tube can be rotated within the swivel mount so that the direction of the port can be adjusted.

The swivel mount is attached to a swivel housing. The swivel mount is attached to an upper mount by way of a V-connector. The V-connector includes two Delrin sliders. The swivel mount can be rotated with reference to the swivel housing. A spring, located within the swivel housing, urges the swivel mount in a direction so as to return the camera tube to an upright position if the swivel mount is rotated. A magnet on the swivel housing is used to latch the camera tube to the V-connector.

In operation, the magnet maintains the camera tube in a generally upright position. If the camera tube strikes an obstruction, the camera tube “breaks away” from the magnet, and pivots away from the obstruction, thereby allowing the camera assembly to pass under the object. After the camera tube is past the obstruction, the spring within the swivel mount urges the swivel housing to return the camera tube to the upright position. The magnet then reengages with the camera tube so as to again maintain the camera tube in a generally upright position

A lower mount and bolts are used to fasten the camera assembly to a link in the chain. Obviously, many different means can be used to fasten the camera assembly to the link.

The camera is connected to a recorder assembly. The recorder assembly includes a memory, such as a fixed disk, to record the output of the camera. A power supply assembly includes a power supply. The power supply provides power to the camera, the LED light, and the recorder assembly.

The memory assembly and the power supply are each made integral with a link of the same size and dimension as a normal link in the conveyor chain.

To use the inspection system, the camera assembly is attached to a link in the chain. A link from the chain is removed and the recorder assembly is substituted for the link. A second link is removed from the chain, and the power supply assembly is substituted therefore. The camera assembly and the recorder assembly are connected to the power supply. The camera output is connected to the recorder.

The chain is then started. The memory within the recorder assembly records the output of the camera. A timer within the recorder assembly time stamps the output of the camera within the memory.

After the camera assembly has traversed the conveyor system, the video recorded by the memory can be viewed by connecting the memory to a video monitor. Alternatively, the memory assembly could be removed from the chain prior to viewing the video.

The time stamp allows the location of the camera assembly within the conveyor system when a section of the video was recorded. Thus, problematic areas of the conveyor system can be promptly located.

The inspection system thus provides a cost effective system for inspecting a conveyor system. Further, the system enhances the ability to quickly locate and repair any problematic areas of the conveyor system.

These and other objects, advantages and features of the invention will be more readily understood and appreciated by reference to the detailed description of the drawings.

### BRIEF DESCRIPTION OF THE DRAWINGS

FIG. 1 shows an inspection system

FIG. 2 shows a camera assembly.

FIG. 3 is a cutaway view of camera tube.

FIG. 4 shows a recorder assembly.

FIG. 5 shows a power supply assembly.

### DETAILED DESCRIPTION OF THE DRAWINGS

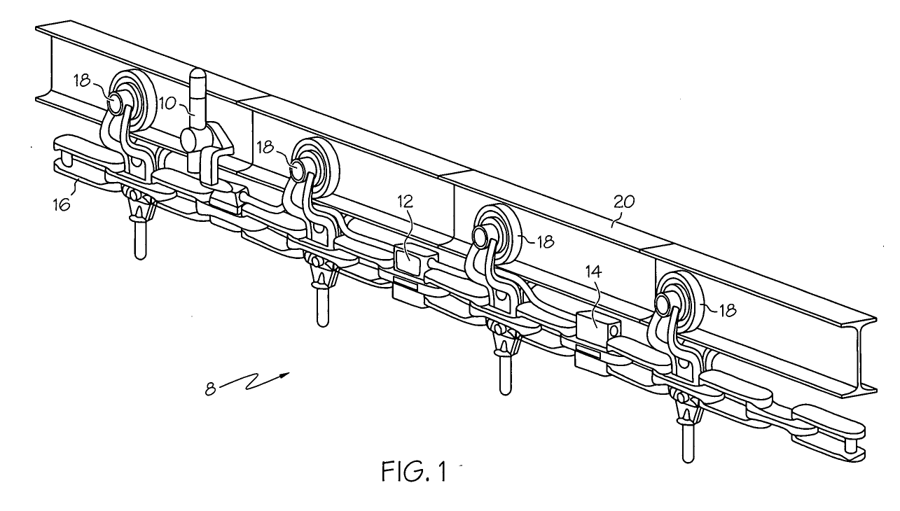

FIG. 1 shows inspection system 8. Inspection system 8 includes a camera assembly 10, a recorder assembly 12 and a power supply assembly 14. Camera assembly 10, recorder assembly 12 and power supply assembly 14 are attachable to chain 16. Chain 16 is attached to trolleys 18. Trolleys 18 ride on I-Beam 20.

Chain 16 is a transport mean for the I-Beam conveyor system. In other conveyor systems, the transport means could be a belt or a roller system.

In operation, camera assembly 10, recorder assembly 12 and power supply assembly 14 are attached to chain 16. Camera assembly 10 and recorder assembly 12 are coupled together. Power supply assembly 14 is likewise coupled to camera assembly 10 and recorder assembly 12. Camera assembly 10 and recorder assembly 12 are activated, and the drive for chain 16 is turned on. Inspection system 8 then traverses the conveyor system with camera assembly 10 and recorder assembly 12 recording the assembly line. After inspection system 8 traverses the entire conveyor system, the inspection system is removed from chain 16. Recorder assembly 12 is then connected to a video monitor. An inspector can then review the recording of the conveyor system to discern the condition of the conveyor system.

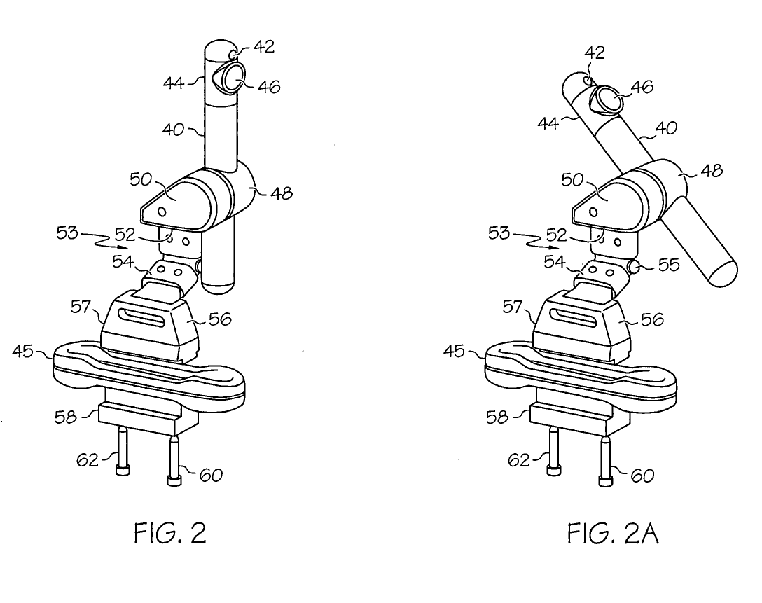

FIG. 2 shows camera assembly 10. Camera assembly 10 includes camera tube 40. To provide sufficient light for recording, LED (Light Emitting Diode) light 42 is located at the top of camera tube 40. LED light 42 may include one or more LEDs. Port 44 allows light to enter camera tube 40. Port 44 may be covered with lens 46.

Camera tube 40 is located within swivel mount 48. Swivel mount 48 is attached to swivel housing 50. Swivel mount 48 is pivotable with respect to swivel housing 50. Swivel housing 50 includes a spring. The spring within swivel housing 50 is arranged to as to urge swivel mount 48 into an upright position so that camera tube 40 is aligned generally vertically.

Swivel mount 48 and swivel housing 50 operate as a displacement means to allow camera tube 40 to move so as not to impede movement of the conveyor system. Alternatively, camera assembly 10 could be equipped with a proximity detector coupled to a motor or a pneumatic device capable of moving camera tube 40 out of the way of any obstruction prior to contact with the obstruction. For example, camera tube 40 could be collapsible or vertically movable.

FIG. 2A shows camera tube 40 after striking an object. Magnet 55, located on V-connector 51, magnetically retains camera tube 40 in the upright position. With sufficient force applied to camera tube 40, camera tube 40 will break the magnetic bond with magnet 55, and rotate. During operation, if camera tube 40 strikes any object, it will temporarily be rotated out of the way of the object. Once it passes an object, the spring within swivel housing 50 will cause swivel mount 48 to return camera tube 40 to the upright position. When returned to the upright position, magnet 55 will once again hold camera tube 40 in an upright position.

Delrin sliders 52, 54 attach swivel mount 50 to upper mount 56. Upper mount 56 includes connector 57. Connector 57 includes both a power connector and a connector from a sensor array located within camera tube 40. Lower mount 58 attaches to upper mount 56 by way of bolts 60, 62.

The camera assembly could be attached to the chain by any of a number of means. For example, camera assembly could be made integral with a chain link, thereby allowing the chain link to be replaced with the camera assembly. The camera could be provided with a mounting bracket that could be adapted to the top or bottom of a chain link. Alternatively, the camera could be bolted or clamped to the trolley bracket which supports the trolley wheel or to the carrier trolley which is guided in the free rail on both overhead and inverted power and free conveyor systems. Also, the Camera could be installed in a chain link and positioned to view the chain travel through conveyor drives, around roller turns and traction wheel turns. Camera could also be installed in a chain link and positioned inverted to view the inside of the power rail on inverted power and free conveyors.

Camera tube 40 is adjustable vertically within swivel mount 48, allowing the height of the port 44 to be adjusted relative to male chain link 45.

In operation, camera assembly 10 is attached to chain link 45 by way of lower mount 58 and upper mount 56. The position of port 44 is then adjusted to an appropriate height.

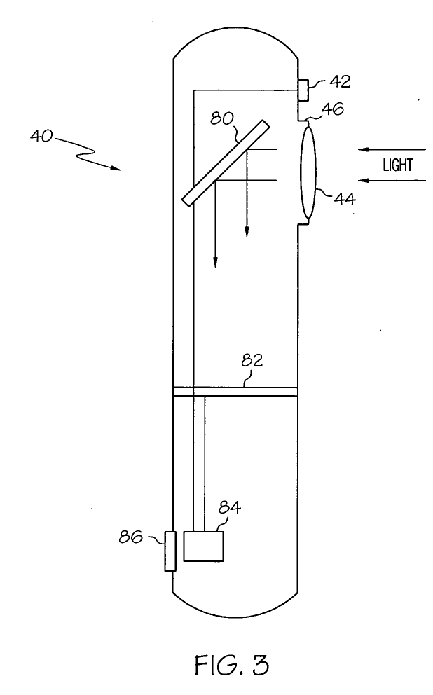

FIG. 3 is a cutaway view of camera tube 40. LED light 42 is located above port 44. Port 44 may be covered by lens 46. Light entering port 44 is reflected off mirror 80 and onto camera 82. Camera 82 could be a CCD (Charge Coupled Diode) image array or any similar type of image sensor. Camera 82 is connected to connector 84. Connector 84 receives data from camera 82 and provides power to both Camera 82 and LED light 42.

Magnet 86 is located on camera tube 40. Magnet 86 is used to retain camera tube 40 in a generally upright position and eliminate any pendulum type motion which would degrade the video quality.

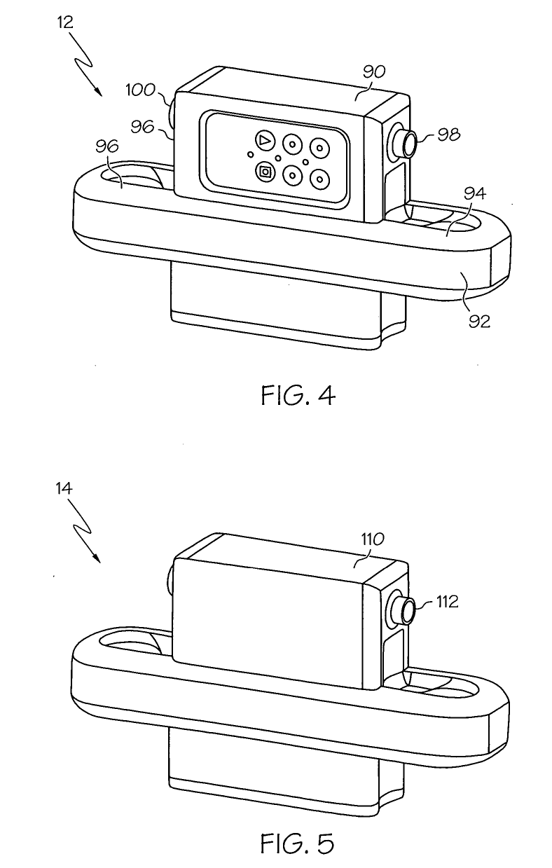

FIG. 4 shows recorder assembly 12. Recorder assembly 12 consists of memory 90 and recorder link 92. Memory 90 and link recorder 92 are integral. Recorder assembly 12 includes holes 94, 96. Recorder assembly 12 is the same length as a link in chain 16, thereby allowing recorder assembly 12 to replace a link within chain 16. Memory 90 includes video input 98 and power input 100.

Memory 90 is a hard disk drive. Video output from Camera 82 is stored on the drive for later playback. Memory 90 could be any type of device suitable for recording video, such as a tape, a flash memory, or random access memory.

Alternatively, if camera assembly 10 were equipped with a transceiver, camera assembly 10 could broadcast the output of camera 82 for remote viewing and recording.

FIG. 5 shows power supply assembly 14. Power supply assembly 14 includes power supply 110. Power supply assembly 14 is the same length as a link in chain 16. Power supply 110 supplies power for both camera assembly 10 and recorder assembly 12 by way of power outlet 112.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A conveyor inspection system for inspecting a conveyor system having a transport means comprising:
a camera; and
a conveyor attachment means for attachment to the transport means.

2. The conveyor inspection system of claim 1 further comprising:
a displacement means allowing movement of the camera so as to avoid impeding movement of the transport means.

3. The conveyor inspection system of claim 2 further comprising:
a memory coupled to the camera for recording the output of the camera.

4. The conveyor inspection system of claim 3 where the transport means is a chain having a plurality of links, where the memory is integral with a link.

5. The conveyor inspection system of claim 4 where the vertical position of the camera is adjustable.

6. The conveyor inspection system of claim 5 where the camera is located within a camera tube.

7. The conveyor inspection system of claim 6 where the camera tube is attached to a swivel for allowing the camera tube to rotate.

8. The conveyor inspection system of claim 7 where the swivel comprises a swivel housing and a swivel mount.

9. The conveyor inspection system of claim 8 further comprising a magnet for holding the camera tube in a generally upright position.

10. The conveyor inspection system of claim 9 further comprising a port located on the camera tube for allowing light to reach the camera.

11. The conveyor inspection system of claim 10 further comprising a mirror for directing light onto the camera.

12. The conveyor inspection system of claim 11 further comprising a lens, the lens covering the port.

13. The conveyor inspection system of claim 12 further comprising a light for illuminating a viewing area for the camera.

14. The conveyor inspection system of claim 13 further comprising a power supply for providing power to the light and the camera.

15. A power supply assembly for incorporating in a chain, the chain having a plurality of links, the links having a link size, comprising a power supply and a power supply link, the link having the same dimensions as the link size.

16. A memory assembly for incorporating in a chain, the chain having a plurality of links, the links having a link size, comprising a memory and a power supply link, the link having the same dimensions as the link size.

17. A camera assembly for a conveyor system comprising:
a camera tube;
a camera located within the camera tube;
a port for allowing light to reach the camera; and
displacement means for moving the camera tube when the camera tube encounter an obstruction.

18. The camera assembly of claim 17 where the displacement means is a swivel.

19. The camera assembly of claim 18 where the camera tube is attached to the swivel, the camera tube being adjustable vertically within the swivel.

20. The camera assembly of claim 19 where the camera tube is rotatable within the swivel.

21. The camera assembly of claim 20 further comprising a latch for maintaining the camera tube in an upright position.

22. The camera assembly of claim 21 where the latch comprises a magnet.

23. The camera assembly of clam 22 further comprising a lens located on the port so as to assist in focusing light on the camera.

24. The camera assembly of claim 23 further comprising a mirror for deflecting light onto the camera, the mirror located within the camera tube.
